(19) United States
(12) Patent Application Publication
(10) Pub. No.: US 2024/0022589 A1
(43) Pub. Date: Jan. 18, 2024

(54) RISK ANALYSIS DEVICE, ANALYSIS TARGET ELEMENT DETERMINATION DEVICE, AND METHOD

(71) Applicant: NEC Corporation, Minato-ku Tokyo (JP)

(72) Inventors: Masaki INOKUCHI, Tokyo (JP); Tomohiko YAGYU, Tokyo (JP); Shunichi KINOSHITA, Tokyo (JP); Hirofumi UEDA, Tokyo (JP)

(73) Assignee: NEC Corporation, Minato-ku Tokyo (JP)

(21) Appl. No.: 18/032,632

(22) PCT Filed: Oct. 27, 2020
(86) PCT No.: PCT/JP2020/040219

§ 371 Date: Apr. 19, 2023

(51) Int. Cl. H04L 9/40

(52) U.S. Cl. CPC H04L 63/1433; H04L 63/1491; H04L 63/20; H04L 63/104

(57) ABSTRACT

A risk analysis is conducted without increasing the computational cost. A grouping means groups a plurality of hosts included in a system to be analyzed into a plurality of groups. A virtual analysis element generation means generates at least one virtual analysis element for each of the plurality of groups. An analysis means analyzes whether an attack against the virtual analysis element being an end point of an attack is possible by using the virtual analysis element. An analysis target element determination means determines, as a target of a risk analysis, a host corresponding to the virtual analysis element included in a path where the attack occurs among hosts included in the system to be analyzed. An analysis means analyzes whether an attack against the host being the end point of the attack is possible for the host determined as a target of the risk analysis.

### TECHNICAL FIELD

The present disclosure relates to a risk analysis apparatus, an analysis target element determination apparatus, a risk analysis method, an analysis target element determination method, and a computer readable medium.

### TECHNICAL FIELD

As related art, Patent Literature 1 discloses a system that includes a security analysis system, an optimization apparatus, and a handling function control apparatus. In the system disclosed in Patent Literature 1, the optimization apparatus collects cyber-attack information and system information from the security analysis system. The cyber-attack information includes the type of a cyber-attack, the identifier of an attacker, the identifier of a victim, and information of an effective handling function. The system information is information about the whole system including equipment that has received a cyber-attack. The system information includes network configuration information, handling function information for each handling point on the network, and resource usage information of the handling point.

The optimization apparatus identifies an attack path of a cyber-attack on the basis of the collected cyber-attack information and system information. To be more specific, the optimization apparatus retrieves the collected IP (Internet Protocol) address of the attacker's terminal and IP address of the victim's terminal, and identifies a path from the attacker's terminal to the victim's terminal as an attack path. The optimization apparatus is equipment located on an attack path, and it extracts equipment having an effective handling function for the cyber-attack as candidates for a handling point. The optimization apparatus selects a handling point from the extracted candidates for a handling point.

After that, the optimization apparatus outputs the selected handling point and the effective handling function to the handling function control apparatus, and thereby causes the handling function control apparatus to execute the handling function.

### CITATION LIST

### Patent Literature

Patent Literature 1: International Patent Publication No. WO2016/076207

### SUMMARY OF INVENTION

### Technical Problem

In recent years, threats of cyber-attacks have not been limited to the fields of ICT (Information and Communication Technology), and cases of harm from such threats have been occurring also in the fields of control systems and IoT (Internet of Things). Particularly, in control systems, there have been cases that pose a threat to the operation of critical infrastructures, such as a shutdown of an electrical power system or plant. To defend against the threats of cyber-attacks, it is important to clarify the security risk of a system, implement countermeasures, and thereby reduce the risk.

In an analysis of security risks, several attack scenarios are assumed. The attack scenario contains an entry point used for an attack, a final attack target, and the type of a final attack, for example. For an attack scenario, a security risk analysis apparatus deductively infers an attack procedure from attack conditions by referring to system configuration information or the like, and thereby retrieves an attack path. A graph showing an attack procedure in an attack path and conditions for each attack procedure in graph form is called “attack graph” or “attack tree”.

In the above case, when the number of hosts included in a system to be analyzed is large, the computational cost required for the generation of the attack graph is enormous. In Patent Literature 1, the optimization apparatus merely identifies a path from an attacker's terminal to a victim's terminal as an attack path, and it does not infer the attack procedure. Therefore, Patent Literature 1 does not provide a means for solving the above-described problem. It is desirable to conduct a risk analysis without increasing the computational cost even when a large number of hosts are included in a system.

In view of the above-described circumstances, an object of the present disclosure is to provide risk analysis apparatus and method, analysis target element determination apparatus and method, and a computer readable medium capable of conducting a risk analysis without increasing the computational cost even for a complicated system.

### Solution to Problem

In order to achieve the above object, according to a first aspect of the present disclosure, there is provided an analysis target element determination apparatus. The analysis target element determination apparatus includes grouping means for grouping a plurality of hosts included in a system to be analyzed into a plurality of groups, each group including one or more hosts; virtual analysis element generation means for generating at least one virtual analysis element for each of the plurality of groups; analysis means for analyzing whether an attack against the virtual analysis element of a group where a host being an end point of the attack belongs is possible from the virtual analysis element of a group where a host being a starting point of the attack belongs by using the virtual analysis element; and analysis target element determination means for determining, as a target of a risk analysis, a host corresponding to the virtual analysis element included in a path where the attack occurs among hosts included in the system to be analyzed on the basis of an analysis result of the analysis means.

According to a second aspect of the present disclosure, there is provided a risk analysis apparatus. The risk analysis apparatus includes grouping means for grouping a plurality of hosts included in a system to be analyzed into a plurality of groups, each group including one or more hosts; virtual analysis element generation means for generating at least one virtual analysis element for each of the plurality of groups; first analysis means for analyzing whether an attack against the virtual analysis element of a group where a host being an end point of the attack belongs is possible from the virtual analysis element of a group where a host being a starting point of the attack belongs by using the virtual analysis element; analysis target element determination means for determining, as a target of a risk analysis, a host corresponding to the virtual analysis element included in a path where the attack occurs among hosts included in the system to be analyzed on the basis of an analysis result of the first analysis means; and second analysis means for analyzing whether an attack against the host being the end point of the attack is possible from the host being the starting point of the attack, for the host determined as a target of the risk analysis by the analysis target element determination means.

According to a third aspect of the present disclosure, there is provided an analysis target element determination method. The analysis target element determination method includes grouping a plurality of hosts included in a system to be analyzed into a plurality of groups, each group including one or more hosts; generating at least one virtual analysis element for each of the plurality of groups; analyzing whether an attack against the virtual analysis element of a group where a host being an end point of the attack belongs is possible from the virtual analysis element of a group where a host being a starting point of the attack belongs by using the virtual analysis element; and determining, as a target or a risk analysis, a host corresponding to the virtual analysis element included in a path where the attack occurs among hosts included in the system to be analyzed on the basis of a result of the analysis.

According to a fourth aspect of the present disclosure, there is provided a risk analysis method. The risk analysis method includes grouping a plurality of hosts included in a system to be analyzed into a plurality of groups, each group including one or more hosts; generating at least one virtual analysis element for each of the plurality of groups; analyzing whether an attack against the virtual analysis element of a group where a host being an end point of the attack belongs is possible from the virtual analysis element of a group where a host being a starting point of the attack belongs by using the virtual analysis element; determining, as a target of a risk analysis, a host corresponding to the virtual analysis element included in a path where the attack occurs among hosts included in the system to be analyzed on the basis of a result of the analysis; and analyzing whether an attack against the host being the end point of the attack is possible from the host being the starting point of the attack for the host determined as a target of the risk analysis.

According to a fifth aspect of the present disclosure, there is provided a computer readable medium. The computer readable medium stores a program causing a computer to execute a process including grouping a plurality of hosts included in a system to be analyzed into a plurality of groups, each group including one or more hosts; generating at least one virtual analysis element for each of the plurality of groups; analyzing whether an attack against the virtual analysis element of a group where a host being an end point of the attack belongs is possible from the virtual analysis element of a group where a host being a starting point of the attack belongs by using the virtual analysis element; and determining, as a target or a risk analysis, a host corresponding to the virtual analysis element included in a path where the attack occurs among hosts included in the system to be analyzed on the basis of a result of the analysis.

According to a sixth aspect of the present disclosure, there is provided a computer readable medium. The computer readable medium stores a program causing a computer to execute a process including grouping a plurality of hosts included in a system to be analyzed into a plurality of groups, each group including one or more hosts; generating at least one virtual analysis element for each of the plurality of groups; analyzing whether an attack against the virtual analysis element of a group where a host being an end point of the attack belongs is possible from the virtual analysis element of a group where a host being a starting point of the attack belongs by using the virtual analysis element; determining, as a target of a risk analysis, a host corresponding to the virtual analysis element included in a path where the attack occurs among hosts included in the system to be analyzed on the basis of a result of the analysis; and analyzing whether an attack against the host being the end point of the attack is possible from the host being the starting point of the attack for the host determined as a target of the risk analysis.

### Advantageous Effects of Invention

Risk analysis apparatus and method, analysis target element determination apparatus and method, and a computer readable medium according to the present disclosure are capable of conducting a risk analysis without increasing the computational cost even for a complicated system.

### BRIEF DESCRIPTION OF DRAWINGS

FIG. 1 is a block diagram showing a schematic configuration of a risk analysis apparatus according to the present disclosure.

FIG. 2 is a block diagram showing a risk analysis apparatus according to one example embodiment of the present disclosure.

FIG. 3 is a block diagram showing a system to be analyzed by partitioning analysis.

FIG. 4 is a block diagram showing an analysis target to be analyzed by partitioning analysis.

FIG. 5 is a view showing an example of a result of partitioning analysis.

FIG. 6 is a block diagram showing an example of a system to be analyzed.

FIG. 7 is a view showing a specific example of a table showing the correspondence between a running service and an endpoint state.

FIG. 8 is a block diagram showing a part of a system to be analyzed.

FIG. 9 is a block diagram showing a representative host generated in each subnetwork.

FIG. 10 is a flowchart showing an operation procedure in a risk analysis apparatus.

FIG. 11 is a block diagram showing a configuration example of a computer apparatus.

### EXAMPLE EMBODIMENT

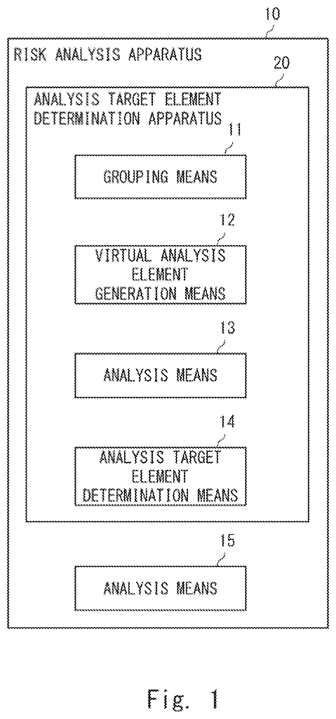

Prior to describing an example embodiment of the present disclosure, an overview of the present disclosure will be described. FIG. 1 shows a schematic configuration of a risk analysis apparatus according to the present disclosure. A risk analysis apparatus 10 includes grouping means 11, virtual analysis element generation means 12, analysis means 13, analysis target element determination means 14, and analysis means 15. In the risk analysis apparatus 10, the grouping means 11, the virtual analysis element generation means 12, the analysis means 13, and the analysis target element determination means 14 constitute an analysis target element determination apparatus 20.

The grouping means 11 groups a plurality of hosts included in a system to be analyzed into a plurality of groups, each group including one or more hosts. The virtual analysis element generation means 12 generates one or more virtual analysis elements for each of the plurality of groups. The analysis means (first analysis means) 13 analyzes whether an attack against a virtual analysis element of a group to which a host at the end point of the attack belongs from a virtual analysis element of a group to which a host at the starting point of the attack belongs is possible or not by using the generated virtual analysis elements.

The analysis target element determination means 14 determines, as a target of a risk analysis, a host corresponding to the virtual analysis element included in a path where an attack occurs among the hosts included in the system to be analyzed on the basis of the analysis result of the analysis means 13. The analysis means (second analysis means) 15 analyzes whether an attack against a host at the end point of the attack from a host at the starting point of the attack is possible or not for the host determined as a target of a risk analysis by the analysis target element determination means 14.

In the present disclosure, the virtual analysis element generation means 12 generates a virtual analysis element for each group. The analysis means 13 retrieves an attack path from the starting point of an attack to the end point of the attack by using the virtual analysis elements. The analysis target element determination means 14 determines a host corresponding to the virtual analysis element included in the attack path as a target of a risk analysis in the analysis means 15. In this manner, the present disclosure allows the reduction of the computational cost in the analysis means 15 compared with the case of performing a risk analysis on the whole system.

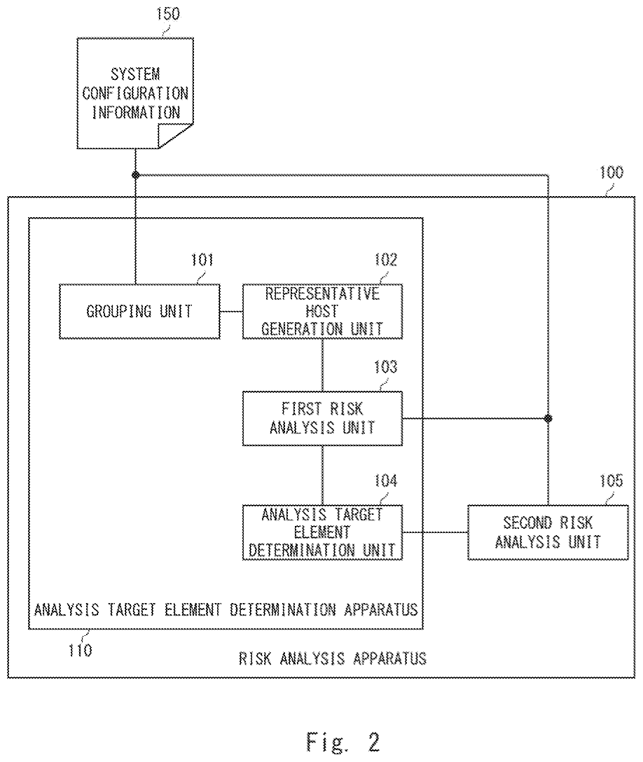

An example embodiment of the present disclosure will be described hereinafter in detail. FIG. 2 shows a risk analysis apparatus according to one embodiment of the present disclosure. A risk analysis apparatus 100 includes a grouping unit 101, a representative host generation unit 102, a first risk analysis unit 103, an analysis target element determination unit 104, and a second risk analysis unit 105. In the risk analysis apparatus 100, the grouping unit 101, the representative host generation unit 102, the first risk analysis unit 103, and the analysis target element determination unit 104 constitute an analysis target element determination apparatus 110. The risk analysis apparatus 100 corresponds to the risk analysis apparatus 10 shown in FIG. 1. The analysis target element determination apparatus 110 corresponds to the analysis target element determination apparatus 20 shown in FIG. 1.

In this example embodiment, it is assumed that the risk analysis apparatus 100 analyzes security risks in a system to be analyzed by using partitioning analysis. In this example embodiment, the partitioning analysis is a technique that analyzes risks in the whole system by partitioning the whole system into predetermined units, performing a risk analysis on each partitioned unit, and combining a risk partitioning result of each partitioned unit.

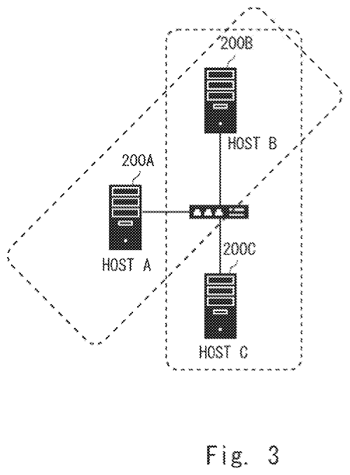

FIG. 3 shows a system to be analyzed by partitioning analysis. This system includes a host (host A) 200A, a host (host B) 200B, and a host (host C) 200C. In this example, it is assumed that the host 200A is a host being an entry point of an attack, and the host 200C is a host being a target of an attack. In the partitioning analysis, it is analyzed whether an attack from the host 200A to the host 200B is possible not, and also whether an attack from the host 200B to the host 200C is possible or not. The risk analysis apparatus 100 combines an analysis result of the host 200A and the host 200B and an analysis result of the host 200B and the host 200C and thereby analyzes whether an attack from the host 200A to the host 200C is possible or not.

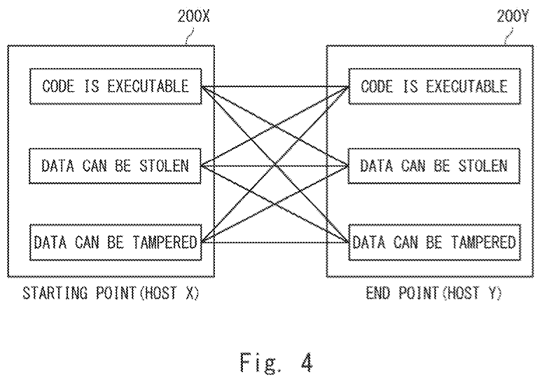

FIG. 4 shows an analysis target to be analyzed by partitioning analysis. In this example, it is assumed that a host (host X) 200X is a host that is the starting point of a partitioning analysis, and a host (host Y) 200Y is a host that is the end point of the partitioning analysis. Each of the hosts 200X and 200Y has three states: “code is executable”, “data can be stolen”, and “data can be tampered”. In the partitioning analysis, it is analyzed whether a transition is possible from each state of the host 200X being the starting point to each state of the host 200Y being the end point. In FIG. 4, each of a plurality of lines connecting each state of the host 200X and each state of the host 200Y indicates a unit of analysis (analysis target element). Note that a host being the starting point and a host being the end point can be the same host. In this case, it is analyzed whether a transition is possible from each state of the host 200X to another state of the host 200X, for example.

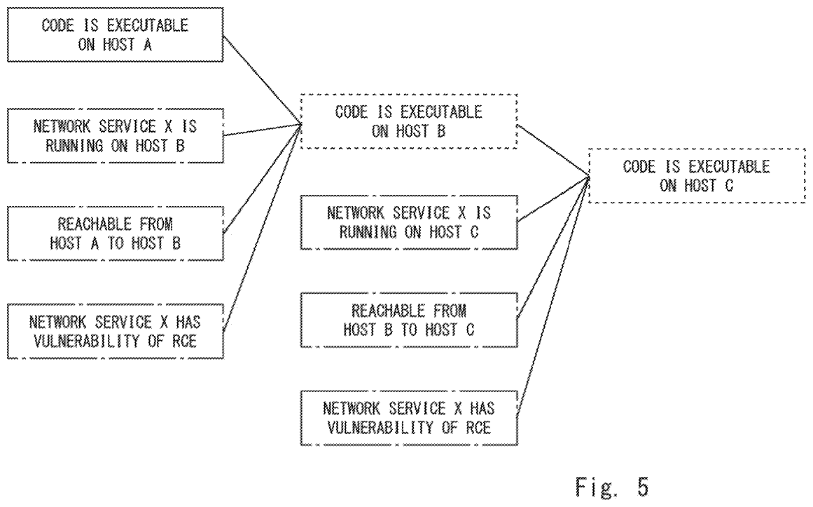

FIG. 5 shows an example of a result of partitioning analysis. In a partitioning analysis of the host 200A and the host 200B, the risk analysis apparatus 100 assumes as a precondition that “code is executable on host A”. The risk analysis apparatus 100 acquires information “network service X is running on host B”, “reachable from host A to host B”, and “network service X has vulnerability of RCE (Remote Code Execution)” from system configuration information. The risk analysis apparatus 100 draws the interference “code is executable on host B” on the basis of the state “code is executable on host A” and the acquired information.

In a partitioning analysis of the host 200B and the host 200C, the risk analysis apparatus 100 assumes as a precondition that “code is executable on host B”. The risk analysis apparatus 100 acquires information “network service X is running on host C” “reachable from host B to host C”, and “network service X has vulnerability of RCE” from system configuration information. The risk analysis apparatus 100 draws the interference “code is executable on host C” on the basis of the state “code is executable on host B” and the acquired information. By combining the analysis results of the two partitioning analyses, the analysis result that a code is executable on the host 200C when a code is executable on the host 200A is obtained.

Since an analysis is performed in a partitioned range in the partitioning analysis, the partitioning analysis has an advantage that the load on each analysis is reduced compared with the case of analyzing the whole system. Further, it has an advantage of performing analyses of a plurality of partitioned units in parallel. On the other hand, since it is unclear whether an attack reaches from an entry point host to a final attack target host in an analysis of each partitioned unit, the partitioning analysis has a disadvantage that an analysis is carried out on an unnecessary part in some cases.

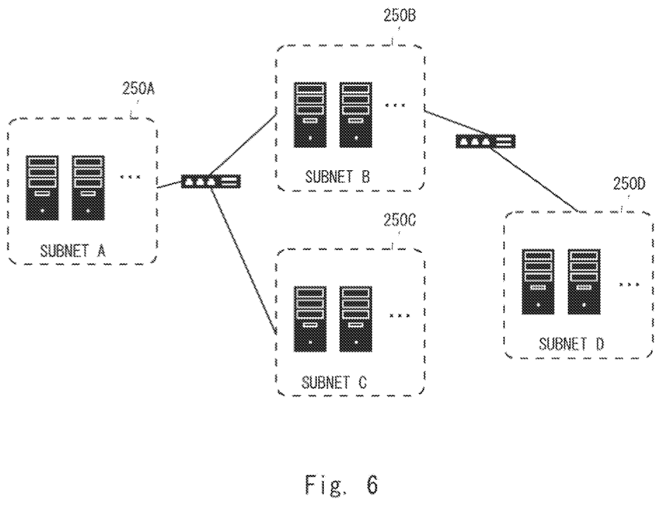

FIG. 6 shows an example of a system to be analyzed. In this example, a network includes four subnetworks (subnets). To be more specific, a network includes a subnet (subnet A) 250A, a subnet (subnet B) 250B, a subnet (subnet C) 250C, and a subnet (subnet D) 250D. It is assumed that the subnet 250A includes a host that is an entry point (initial position), and the subnet 250D includes a host that is a final attack target.

In the partitioning analysis, an analysis whose starting point is a host in the subnet 250A and end point is a host in the subnet 250B (analysis between A and B) and an analysis whose starting point is a host in the subnet 250A and end point is a host in the subnet 250C (analysis between A and C) are performed. Further, an analysis whose starting point is a host in the subnet 250B and end point is a host in the subnet 250C (analysis between B and C) is performed. Furthermore, an analysis whose starting point is a host in the subnet 250B and end point is a host in the subnet 250D (analysis between B and D) and an analysis whose starting point is a host in the subnet 250C and end point is a host in the subnet 250D (analysis between C and D) are performed.

However, in the above-described network, the subnet 250C is not connected to the subnet 250D. Thus, it is considered that a host in the subnet 250C is not included in an attack path of an attack against a host in the subnet 250D from a host in the subnet 250A. Therefore, a partitioning analysis whose starting point or end point is a host in the subnet 250C is actually unnecessary. In the partitioning analysis, the computational cost increases due to an analysis conducted on an unnecessary part. In one aspect of this example embodiment, the risk analysis apparatus 100 capable of reducing the unnecessary computational cost in partitioning analysis is provided.

Referring back to FIG. 2, the grouping unit 101 refers to system configuration information 150 and groups a plurality of hosts included in a system into a plurality of groups, each group including one or more hosts. The system configuration information includes information about a host and information about a connection between hosts, for example. The information about a host includes information such as an IP address, a subnet mask, host firewall configuration, installed software, an OS (Operating System) (including its version), a running service, an empty port number, the presence or absence of a USB (Universal Serial Bus) port, and vulnerability information, for example. The information about a host further includes information such as a host type, the presence or absence of a user operation, and stored credential information. The “host type” includes a general PC (Personal Computer), a router, a firewall, a file server, an active directory server, and a DNS (Domain Name Server) server, for example. The information about a connection between hosts includes information such as configuration of a network firewall and data-flow information. The “data-flow information” includes information such as “file sharing by SMB is done between hosts A and B” and “operation of migrating file from host C to D by using USB memory”, for example.

The grouping unit 101 groups hosts for each subnetwork, for example. The subnetwork to which each host belongs can be determined on the basis of address information. The grouping unit 101 acquires the IP address of each host from the system configuration information 150, and determines that hosts with the same network address belong to the same subnetwork. The grouping unit 101 groups hosts belonging to the same subnetwork into the same group.

Alternatively, the grouping unit 101 may group hosts for each range separated by a predetermined boundary such as the boundary of security, for example, in a network. For example, the grouping unit 101 may group hosts for each network range separated using a firewall. For example, the grouping unit 101 groups hosts on the basis of the IP address and the host type contained in the system configuration information 150. The grouping unit 101 determines that hosts with the same network address of the IP address belong to the same subnetwork, for example. The grouping unit 101 extracts hosts having a plurality of IP addresses, and groups hosts whose host type is not a firewall, such as hosts in a subnetwork connected by hosts with a router or a plurality of NIC (Network Interface Card), into the same group.

Further, the grouping unit 101 may group hosts for each role assigned to a host such as an office PC, a file server, a log server, a springboard server, a control server, and HMI (Human Machine Interface). For example, the grouping unit 101 acquires the host type of each host from the system configuration information 150. The grouping unit 101 may group hosts of the same host type into the same group.

The grouping unit 101 may group hosts on the basis of the configuration of each host. The grouping unit 101 may group hosts on the basis of an arbitrary combination of information contained in the system configuration information 150, for example. For example, the grouping unit 101 may group a plurality of hosts in which the same OS and software are installed into the same group. The grouping unit 101 may group hosts according to information manually input by a user. The above-described grouping techniques may be combined as appropriate. The grouping unit 101 corresponds to the grouping means 11 shown in FIG. 1.

The representative host generation unit 102 generates one or more virtual analysis elements for each of the plurality of groups grouped by the grouping unit 101. In this example embodiment, the representative host generation unit 102 generates a representative host, which is a virtual host corresponding to one or more hosts among hosts belonging to a group, as a virtual analysis element. The representative host generation unit 102 corresponds to the virtual analysis element generation means 12 shown in FIG. 1.

There are several methods for generating a representative host. As a first method, the representative host generation unit 102 may merge attackable elements, which are elements that can be attacked, contained in the system configuration information 150 of one or more hosts belonging to the same group, and use the merged attackable elements as attackable elements of the representative host. The attackable elements contained in the system configuration information 150 include a running service (empty port number), the presence or absence of a USB port, vulnerability information, the presence or absence of a user operation, stored credential information, and data-flow information, for example. The “running service” includes a network service such as SSH (Secure Shell), FTP (File Transfer Protocol), telnet (Teletype network), and SMB (Server Message Block), for example.

Note that, in the generation of a representative host, the representative host generation unit 102 can rewrite information of a host with information of a representative host. For example, in the information of data-flow, the representative host generation unit 102 can rewrite each host with a representative host of a group to which each host belongs. For example, information “file sharing by SMB is done between hosts A and B” may be rewritten with information “file sharing by SMB is done between representative host of group to which host A belongs and representative host of group to which host B belongs”.

Likewise, the representative host generation unit 102 can rewrite information of each host with information of a representative host of a group to which each host belongs in host firewall information and network firewall information. For example, it is assumed that the IP address of the host A is “192.168.10.1”, and the IP address of the host B is “192.168.20.1”. It is also assumed that the firewall information is “communication with TCP port number 22 from 192.168.10.1 to 192.168.20.1 is allowed”. It is also assumed that the IP address of a representative host of a group to which the host A belongs is “192.168.10.100”, and the IP address of a representative host of a group to which the host B belongs is “192.168.20.100”. In this case, the representative host generation unit 102 can rewrite the above-described firewall information with “communication with TCP port number 22 from 192.168.10.100 to 192.168.20.100 is allowed”.

For the IP address and the host type, the representative host generation unit 102 may use the IP address and the host type of a host arbitrarily selected from a plurality of hosts belonging to the same group as the IP address and the host type of a representative host. Alternatively, the representative host generation unit 102 may use dummy values as the IP address and the host type of a representative host. The representative host generation unit 102 may merge the IP address and the host type of hosts in a group.

As a second method, the representative host generation unit 102 may acquire attackable elements of each host from the system configuration information 150, and generate a representative host on the basis of the number of attackable elements. The representative host generation unit 102 may select one or more hosts with a large number of attackable elements among hosts belonging to the same group, and generate a host having the same configuration as the selected host as a representative host. For example, the representative host generation unit 102 may select a host in which the number of attackable elements is the largest in each group. Alternatively, the representative host generation unit 102 may select one or more hosts in which the number of attackable elements is a predetermined number or more in each group. The representative host generation unit 102 may generate a representative host on the basis of the number of specified attackable elements, such as the number of vulnerability information or the number of running services.

As a third method, the representative host generation unit 102 may select a host having an attackable element that can be attacked from a host of another group among one or more hosts belonging to the same group, and generate a host having the same configuration as the selected host as a representative host. The representative host generation unit 102 can identify a host having an attackable element that can be attacked from a host of another group on the basis of the data-flow information, host firewall information, and network firewall information contained in the system configuration information 150, for example.

As a fourth method, the representative host generation unit 102 may generate a representative host for each host having an attackable element that reaches each endpoint state of partitioning analysis. The representative host generation unit 102 stores, as a table, which endpoint state of partitioning analysis is reached for each analysis element, for example. The representative host generation unit 102 refers to the stored table and the system configuration information 150, and determines which endpoint state an element in each host reaches.

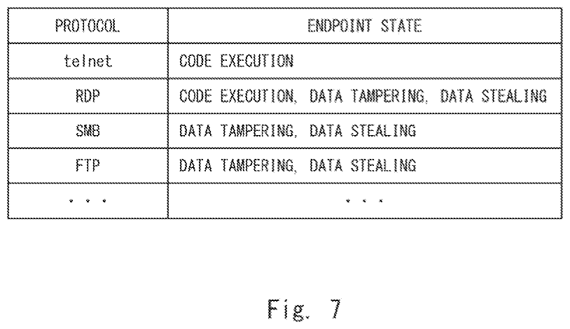

FIG. 7 shows a specific example of a table showing the correspondence between a running service and an endpoint state. The representative host generation unit 102 stores a table that associates a protocol used in a service with an endpoint state to which a transition is possible by an attack using this protocol, for example. For example, when “telnet” is used in a certain host, the representative host generation unit 102 determines that this host has an attackable element that reaches “code execution”. For example, when “RDP (Remote Desktop Protocol)” is used in a certain host, the representative host generation unit 102 determines that this host has an attackable element that reaches “code execution”, “data tampering”, and “data stealing”.

Although the three states of “code execution”, “data tampering”, and “data stealing” are considered as the endpoint states in FIG. 7, the endpoint states are not limited thereto. For example, when the states such as “stealing of authentication information” and “breakdown” are considered as the endpoint states of partitioning analysis, the representative host generation unit 102 may store a table that associates those states with attackable elements.

For vulnerability also, the representative host generation unit 102 stores a table that associates vulnerability with an endpoint state to which a transition is possible by an attack using this vulnerability. For data-flow information, the representative host generation unit 102 may determine that the state reaches the final state of “data tampering” or “data stealing” for the related host. For example, the representative host generation unit 102 may merge attackable elements that reach the same final state in hosts in a group and generate a representative host corresponding to each final state.

The above-described methods for generating a representative host may be combined as appropriate. For example, when a plurality of hosts are selected in the third method, the representative host generation unit 102 may merge the elements that can be configured in the selected plurality of hosts according to the first method or the second method, or may further select a host with a large number of attackable elements.

The first risk analysis unit 103 analyzes potential risks in a system by using the representative host generated by the representative host generation unit 102. The first risk analysis unit 103 deductively infers an attack procedure for each of several attack scenarios assumed, and retrieves an attack path. The attack scenario contains an entry point used for an attack, a final attack target, and the type of a final attack. The first risk analysis unit 103 analyzes whether an attack indicated by the type of the final attack is possible in a representative host of a group to which the host to be attacked belongs when an attack starts from a representative host of a group to which the host being an entry point used for an attack belongs. The first risk analysis unit 103 corresponds to the analysis means 13 shown in FIG. 1.

In this example embodiment, the first risk analysis unit 103 performs a risk analysis by using partitioning analysis. The first risk analysis unit 103 analyzes, for a pair of representative hosts generated by the representative host generation unit 102, whether a transition is possible from each state of a representative host being a starting point to each state of a representative host being an end point by referring to the system configuration information 150.

The first risk analysis unit 103 combines the results of the partitioning analysis, and analyzes whether an attack indicated by the type of the final attack is possible in the representative host corresponding to the final attack target when an attack starts from the representative host corresponding to the entry point used for the attack.

The analysis target element determination unit 104 determines an analysis target element to be analyzed by the second risk analysis unit 105 on the basis of a result of the risk analysis performed by the first risk analysis unit 103. The analysis target element determination unit 104 determines, as a target of a risk analysis, a host corresponding to the virtual analysis element included in a path where an attack occurs among the hosts included in the system to be analyzed on the basis of the analysis result of the first risk analysis unit 103. The analysis target element determination unit 104 corresponds to the analysis target element determination means 14 shown in FIG. 1.

For example, when a representative host is not used for an attack, the analysis target element determination unit 104 excludes hosts in a group of this representative host from a target of analysis. Alternatively, when a specific state of a representative host is not used as the starting point of an attack or as the endpoint state in a partitioning analysis using the representative host, the analysis target element determination unit 104 excludes, for hosts in the group, this state from a target of partitioning analysis. When a representative host is generated corresponding to the endpoint state, the analysis target element determination unit 104 checks whether there is a representative host that is not used for an attack. The analysis target element determination unit 104 identifies a representative host that is not used for an attack and, for hosts in the group, excludes the endpoint state corresponding to the identified representative host from a target of analysis.

For the analysis target element determined by the analysis target element determination unit 104, the second risk analysis unit 105 analyzes potential risks in the system by referring to the system configuration information 150. The risk analysis performed by the second risk analysis unit 105 may be the same as the risk analysis performed by the first risk analysis unit 103 except that a target of the analysis is each host rather than a representative host of each group. The second risk analysis unit 105 is not necessarily separated from the first risk analysis unit 103, and the first risk analysis unit 103 and the second risk analysis unit 105 may be the same functional unit.

The second risk analysis unit 105 analyzes, for a host to be analyzed and its state, whether a transition is possible from each state of a host being the starting point to each state of a host being the end point by referring to the system configuration information 150. The second risk analysis unit 105 combines the results of the partitioning analysis, and analyzes whether an attack indicated by the type of the final attack is possible in the host being the final attack target when an attack starts from the host being the entry point used for the attack. The second risk analysis unit 105 corresponds to the analysis means 15 shown in FIG. 1.

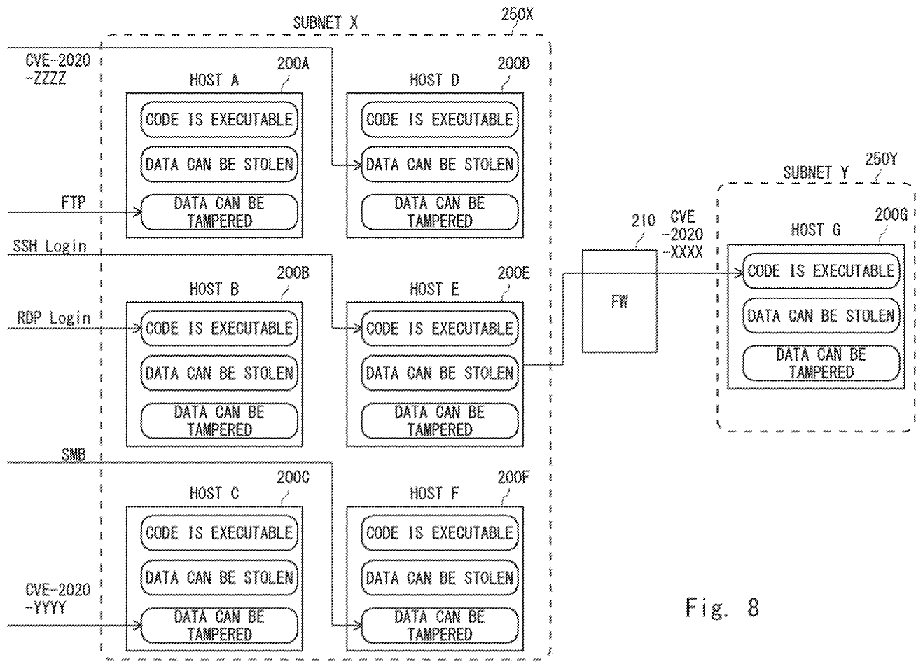

FIG. 8 shows a part of a system to be analyzed. A subnet (subnet X) 250X includes a host 200A, a host 200B, a host 200C, a host (host D) 200D, a host (host E) 200E, and a host (host F) 200F. A subnet (subnet Y) 250Y includes a host (host G) 200G. The subnet 250X is connected to the subnet 250Y through a firewall (FW) 210. It is assumed that the firewall 210 allows communication only from the host 200E to the host 200G.

The host 200A of the subnet 250X has “FTP” as an attackable element that reaches the state “data can be tampered”. The host 200B has “RDP Login” as an attackable element that reaches the state “code is executable”. The host 200C has the vulnerability identified by “CVE(Common Vulnerabilities and Exposures)-2020-YYYY” as an attackable element that reaches the state “data can be tampered”. The host 200D has the vulnerability identified by “CVE-2020-ZZZZ” as an attackable element that reaches “data can be tampered”. The host 200E has “SSH Login” as an attackable element that reaches “code is executable”. The host 200F has “SMB” as an attackable element that reaches “data can be tampered”. The host 200G of the subnet 250Y has the vulnerability identified by “CVE-2020-XXXX” as an attackable element that reaches “code is executable”.

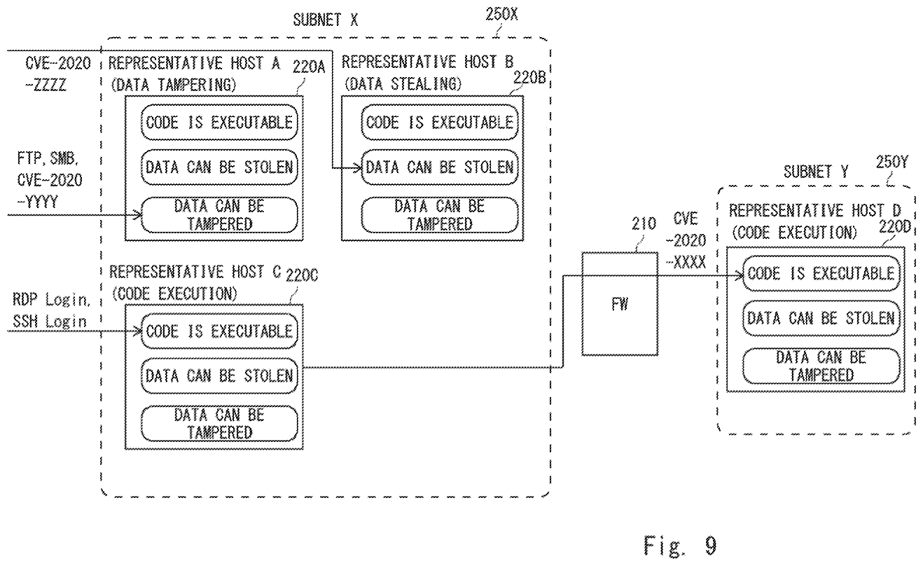

FIG. 9 shows a representative host generated in each subnetwork. The representative host generation unit 102 collects hosts in each subnet for each state. For the subnet 250X, the representative host generation unit 102 generates a representative host (representative host A) 220A corresponding to “data can be tampered”. The representative host 220A has the vulnerability identified by “FTP”, “SMB”, and “CVE-2020-YYYY” as attackable elements.

Further, the representative host generation unit 102 generates a representative host (representative host B) 220B corresponding to “data can be stolen”. The representative host 220B has the vulnerability identified by “CVE-2020-ZZZZ” as an attackable element. Further, the representative host generation unit 102 generates a representative host (representative host C) 220C corresponding to “code is executable”. The representative host 220C has “RDP Login” and “SSH Login” as attackable elements. The representative host generation unit 102 generates a representative host (representative host D) 220D for the subnet 250Y.

The representative host 220A is a representative host corresponding to the hosts 200A, 200C and 200F shown in FIG. 8. The representative host 220B is a representative host corresponding to the host 200D shown in FIG. 8. The representative host 220C is a representative host corresponding to the hosts 200B and 200E shown in FIG. 8. The representative host 220D is a representative host corresponding to the host 200G shown in FIG. 8.

The first risk analysis unit 103 performs a risk analysis by using the representative hosts shown in FIG. 9. According to a result of the risk analysis, an attack from the representative host 220C to the representative host 220D is possible. On the other hand, since communication from the representative hosts 220A and 220B to the representative host 220D is blocked by the firewall 210, an attack from the representative hosts 220A and 220B to the representative host 220D does not occur. In this case, the analysis target element determination unit 104 excludes “data can be tampered” and “data can be stolen” from a target of analysis for the subnet 250X. The second risk analysis unit 105 performs a risk analysis regarding “code is executable” for hosts in the subnet 250X. This reduces an analysis of an unnecessary part in partitioning analysis.

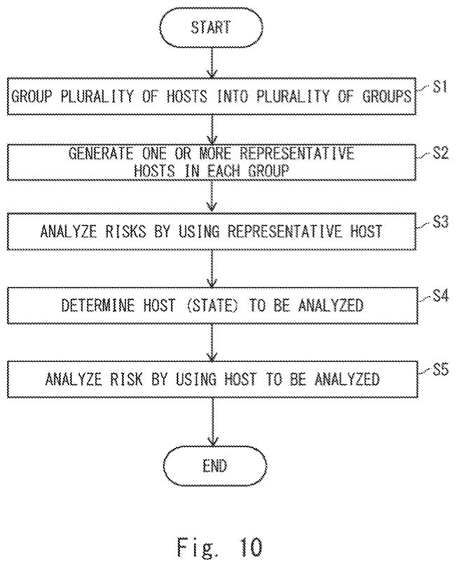

An operation procedure will be described hereinafter. FIG. 10 shows an operation procedure (risk analysis method) in the risk analysis apparatus 100. The grouping unit 101 groups a plurality of hosts included in a system to be analyzed into a plurality of groups on the basis of the system configuration information 150 (Step S1). The representative host generation unit 102 generates one or more representative hosts in each group (Step S2).

The first risk analysis unit 103 analyzes risks in the system to be analyzed by using the representative host generated in Step S2 (Step S3). The analysis target element determination unit 104 determines an analysis target element (a host and its state) on the basis of the risk analysis result in Step S3 (Step S4). In Step S4, the analysis target element determination unit 104 excludes a host and its state corresponding to a representative host that is not used for an attack and its state from an analysis target element in a risk analysis using the representative host, for example. Steps S1 to S4 correspond to an operation procedure (analysis target element determination method) of the analysis target element determination apparatus 110.

For the analysis target element determined in Step S4, the second risk analysis unit 105 performs a detailed risk analysis by referring to the system configuration information 150 (Step S5). When a host and its state corresponding to a representative host not used for an attack and its state are excluded from an analysis target element in Step S4, an analysis is not conducted on an unnecessary part in Step S5. The computational cost is thereby reduced compared with the case where a risk analysis is conducted on all hosts included in a system to be analyzed and their states.

In this example embodiment, the grouping unit 101 groups a plurality of hosts into several groups. The representative host generation unit 102 generates a representative host for each group. The first risk analysis unit 103 performs a risk analysis by using the representative host generated for each group. On the basis of a result of the risk analysis in the first risk analysis unit 103, the analysis target element determination unit 104 determines a representative host that can be used for an attack as an analysis target element of a risk analysis to be performed in the second risk analysis unit 105. An analysis of an unnecessary part is thereby reduced in the risk analysis performed in the second risk analysis unit 105, which allows the reduction of the computational cost compared with the case of performing a risk analysis on the whole system.

Note that, in FIG. 2, an example in which the risk analysis apparatus 100 includes the analysis target element determination apparatus 110 is described. However, the present disclosure is not limited thereto. The risk analysis apparatus 100 and the analysis target element determination apparatus 110 are not necessarily configured as the same apparatus, and they may be configured as separate apparatuses. Further, although an example in which partitioning analysis is mainly used is described in the above-described example embodiment, the present disclosure is not limited thereto. The first risk analysis unit 103 and the second risk analysis unit 105 may perform a risk analysis without partitioning the whole system into predetermined partitioned units. In this case also, the computational cost can be reduced by excluding a part that is not used for an attack from a target of analysis.

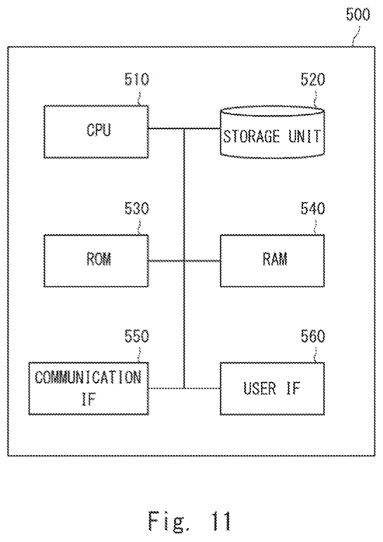

A physical configuration of the risk analysis apparatus is described hereinafter. FIG. 11 shows a configuration example of a computer apparatus that can be used as the risk analysis apparatus 100 and the analysis target element determination apparatus 110. A computer apparatus 500 includes a control unit (CPU: Central Processing Unit) 510, a storage unit 520, a ROM (Read Only Memory) 530, a RAM (Random Access Memory) 540, a communication interface (IF) 550, and a user interface (IF) 560.

The communication IF 550 is an interface for connecting the computer apparatus 500 and a communication network through a wired communication means, a wireless communication means or the like. The user IF 560 includes a display unit such as a display. The user interface 560 further includes an input unit such as a keyboard, a mouse, and a touch panel.

The storage unit 520 is an auxiliary storage device for storing various types of data. The storage unit 520 is not necessarily a part of the computer apparatus 500, and it may be an external storage device or a cloud storage that is connected to the computer apparatus 500 through a network. The storage unit 520 stores the system configuration information 150 shown in FIG. 2, for example.

The ROM 530 is a nonvolatile storage device. A semiconductor storage device such as a flash memory with relatively small capacity can be used for the ROM 530, for example. A program executed by the CPU 510 can be stored in the storage unit 520 or the ROM 530. The storage unit 520 or the ROM 530 stores various programs for implementing the functions of the elements of the risk analysis apparatus 100 or the analysis target element determination apparatus 110, for example.

The above-described program can be stored using any type of non-transitory computer readable media and provided to the computer apparatus 500. The non-transitory computer readable media include any type of tangible storage media. Examples of non-transitory computer readable media include magnetic storage media such as flexible disks, magnetic tapes or hard disks, optical magnetic storage media such as magneto-optical disks, optical disc media such as CD (Compact Disc) or DVD (Digital Versatile Disk), and semiconductor memories such as mask ROM, PROM (Programmable ROM), EPROM (Erasable PROM), flash ROM or RAM (Random Access Memory). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers, or a wireless communication line.

The RAM 540 is a volatile storage device. A semiconductor memory device such as DRAM (Dynamic Random Access Memory) or SRAM (Static Random Access Memory) is used as the RAM 540. The RAM 540 can be used as an internal buffer that temporarily stores data or the like. The CPU 510 develops, on the RAM 540, a program stored in the storage unit 520 or the ROM 530 and executes it. The CPU 510 executes the program, and thereby the functions of the elements of the risk analysis apparatus 100 or the analysis target element determination apparatus 110 are implemented. The CPU 510 may include an internal buffer for temporarily storing data or the like.

While the present disclosure has been described in detail with reference to example embodiments thereof, the present disclosure is not limited to the above-described example embodiments, and various changes and modifications may be made therein without departing from the spirit and scope of the present disclosure.

For example, the whole or part of the example embodiments disclosed above can be described as, but not limited to, the following supplementary notes.

### [Supplementary Note 1]

An analysis target element determination apparatus comprising:
grouping means for grouping a plurality of hosts included in a system to be analyzed into a plurality of groups, each group including one or more hosts;
virtual analysis element generation means for generating at least one virtual analysis element for each of the plurality of groups;
analysis means for analyzing whether an attack against the virtual analysis element of a group where a host being an end point of the attack belongs is possible from the virtual analysis element of a group where a host being a starting point of the attack belongs by using the virtual analysis element; and
analysis target element determination means for determining, as a target of a risk analysis, a host corresponding to the virtual analysis element included in a path where the attack occurs among hosts included in the system to be analyzed on the basis of an analysis result of the analysis means.

### [Supplementary Note 2]

The analysis target element determination apparatus according to Supplementary Note 1, wherein the virtual analysis element generation means generates, as the virtual analysis element, a representative host being a virtual host corresponding to one or more hosts among hosts belonging to the group.

### [Supplementary Note 3]

The analysis target element determination apparatus according to Supplementary Note 2, wherein the virtual analysis element generation means merges attackable elements of hosts belonging to the group, and uses the merged attackable elements as an attackable element of the representative host.

### [Supplementary Note 4]

The analysis target element determination apparatus according to Supplementary Note 2 or 3, wherein the virtual analysis element generation means selects a host with the largest number of attackable elements or one or more hosts with a predetermined number or more of attackable elements among hosts belonging to the group, and uses the attackable element of the selected host as an attackable element of the representative host.

### [Supplementary Note 5]

The analysis target element determination apparatus according to any one of Supplementary Notes 2 to 4, wherein the virtual analysis element generation means selects a host having an attackable element from a host of another group among hosts belonging to the group, and uses the attackable element of the selected host as an attackable element of the representative host.

### [Supplementary Note 6]

The analysis target element determination apparatus according to any one of Supplementary Notes 2 to 5, wherein the analysis target element determination means excludes, from a target of the risk analysis, a host corresponding to the representative host not included in a path where the attack occurs among hosts included in the system to be analyzed.

### [Supplementary Note 7]

The analysis target element determination apparatus according to any one of Supplementary Notes 2 to 6, wherein, in each partitioned unit, which is obtained by partitioning the system to be analyzed into predetermined units, the analysis means analyzes whether a transition is possible from each state of a representative host that is a starting point of the partitioned unit to each state of a representative host that is an end point of the partitioned unit.

### [Supplementary Note 8]

The analysis target element determination apparatus according to Supplementary Note 7, wherein the analysis target element determination means excludes, from a target of the risk analysis, a state of a representative host being the starting point and a state of a representative host being the end point not included in a path where the attack occurs.

### [Supplementary Note 9]

The analysis target element determination apparatus according to Supplementary Note 2, wherein
in each partitioned unit, which is obtained by partitioning the system to be analyzed into predetermined units, the risk analysis analyzes whether a transition is possible from each state of a host that is a starting point of the partitioned unit to each state of a host that is an end point of the partitioned unit, and
the virtual analysis element generation means generates the representative host for each host having an attackable element that reaches each state of the host that is the end point of the partitioned unit.

### [Supplementary Note 10]

The analysis target element determination apparatus according to Supplementary Note 9, wherein the analysis target element determination means identifies a representative host not used for the attack, and excludes, from a target of the risk analysis, a state of a host being an end point corresponding to the identified representative host.

### [Supplementary Note 11]

The analysis target element determination apparatus according to any one of Supplementary Notes 1 to 10, wherein the grouping means groups the hosts for each subnetwork to which the hosts belong.

### [Supplementary Note 12]

The analysis target element determination apparatus according to any one of Supplementary Notes 1 to 11, wherein the grouping means groups the hosts for each range separated by a predetermined boundary.

### [Supplementary Note 13]

The analysis target element determination apparatus according to any one of Supplementary Notes 1 to 12, wherein the grouping means groups the hosts for each role of the hosts.

### [Supplementary Note 14]

The analysis target element determination apparatus according to any one of Supplementary Notes 1 to 13, wherein the grouping means groups the hosts for each configuration of the hosts.

### [Supplementary Note 15]

A risk analysis apparatus comprising:
grouping means for grouping a plurality of hosts included in a system to be analyzed into a plurality of groups, each group including one or more hosts;
virtual analysis element generation means for generating at least one virtual analysis element for each of the plurality of groups;
first analysis means for analyzing whether an attack against the virtual analysis element of a group where a host being an end point of the attack belongs is possible from the virtual analysis element of a group where a host being a starting point of the attack belongs by using the virtual analysis element;
analysis target element determination means for determining, as a target of a risk analysis, a host corresponding to the virtual analysis element included in a path where the attack occurs among hosts included in the system to be analyzed on the basis of an analysis result of the first analysis means; and
second analysis means for analyzing whether an attack against the host being the end point of the attack is possible from the host being the starting point of the attack, for the host determined as a target of the risk analysis by the analysis target element determination means.

### [Supplementary Note 16]

The risk analysis apparatus according to Supplementary Note 15, wherein the virtual analysis element generation means generates, as the virtual analysis element, a representative host being a virtual host corresponding to one or more hosts among hosts belonging to the group.

### [Supplementary Note 17]

The risk analysis apparatus according to Supplementary Note 16, wherein the virtual analysis element generation means merges attackable elements of hosts belonging to the group, and uses the merged attackable elements as an attackable element of the representative host.

### [Supplementary Note 18]

The risk analysis apparatus according to Supplementary Note 16 or 17, wherein the analysis target element determination means excludes, from a target of the risk analysis, a host corresponding to the representative host not included in a path where the attack occurs among hosts included in the system to be analyzed.

### [Supplementary Note 19]

The risk analysis apparatus according to any one of Supplementary Notes 16 to 18, wherein
in each partitioned unit, which is obtained by partitioning the system to be analyzed into predetermined units, the first analysis means analyzes whether a transition is possible from each state of a representative host that is a starting point of the partitioned unit to each state of a representative host that is an end point of the partitioned unit, and
in each partitioned unit, which is obtained by partitioning the system to be analyzed into predetermined units, the second analysis means analyzes whether a transition is possible from each state of a host that is a starting point of the partitioned unit to each state of a host that is an end point of the partitioned unit.

### [Supplementary Note 20]

The risk analysis apparatus according to Supplementary Note 16, wherein
in each partitioned unit, which is obtained by partitioning the system to be analyzed into predetermined units, the second analysis means analyzes whether a transition is possible from each state of a host that is a starting point of the partitioned unit to each state of a host that is an end point of the partitioned unit, and
the virtual analysis element generation means generates the representative host for each host having an attackable element that reaches each state of the host that is the end point of the partitioned unit.

### [Supplementary Note 21]

The risk analysis apparatus according to Supplementary Note 20, wherein the analysis target element determination means identifies a representative host not used for the attack, and excludes, from a target of the risk analysis, a state of a host being an end point corresponding to the identified representative host.

### [Supplementary Note 22]

An analysis target element determination method comprising:
grouping a plurality of hosts included in a system to be analyzed into a plurality of groups, each group including one or more hosts;
generating at least one virtual analysis element for each of the plurality of groups;
analyzing whether an attack against the virtual analysis element of a group where a host being an end point of the attack belongs is possible from the virtual analysis element of a group where a host being a starting point of the attack belongs by using the virtual analysis element; and
determining, as a target or a risk analysis, a host corresponding to the virtual analysis element included in a path where the attack occurs among hosts included in the system to be analyzed on the basis of a result of the analysis.

### [Supplementary Note 23]

A risk analysis method comprising:
grouping a plurality of hosts included in a system to be analyzed into a plurality of groups, each group including one or more hosts;
generating at least one virtual analysis element for each of the plurality of groups;
analyzing whether an attack against the virtual analysis element of a group where a host being an end point of the attack belongs is possible from the virtual analysis element of a group where a host being a starting point of the attack belongs by using the virtual analysis element;
determining, as a target of a risk analysis, a host corresponding to the virtual analysis element included in a path where the attack occurs among hosts included in the system to be analyzed on the basis of a result of the analysis; and
analyzing whether an attack against the host being the end point of the attack is possible from the host being the starting point of the attack for the host determined as a target of the risk analysis.

### [Supplementary Note 24]

A non-transitory computer readable medium storing a program causing a computer to execute a process comprising:
grouping a plurality of hosts included in a system to be analyzed into a plurality of groups, each group including one or more hosts;
generating at least one virtual analysis element for each of the plurality of groups;
analyzing whether an attack against the virtual analysis element of a group where a host being an end point of the attack belongs is possible from the virtual analysis element of a group where a host being a starting point of the attack belongs by using the virtual analysis element; and
determining, as a target or a risk analysis, a host corresponding to the virtual analysis element included in a path where the attack occurs among hosts included in the system to be analyzed on the basis of a result of the analysis.

### [Supplementary Note 25]

A non-transitory computer readable medium storing a program causing a computer to execute a process comprising:
grouping a plurality of hosts included in a system to be analyzed into a plurality of groups, each group including one or more hosts;
generating at least one virtual analysis element for each of the plurality of groups;
analyzing whether an attack against the virtual analysis element of a group where a host being an end point of the attack belongs is possible from the virtual analysis element of a group where a host being a starting point of the attack belongs by using the virtual analysis element;
determining, as a target of a risk analysis, a host corresponding to the virtual analysis element included in a path where the attack occurs among hosts included in the system to be analyzed on the basis of a result of the analysis; and
analyzing whether an attack against the host being the end point of the attack is possible from the host being the starting point of the attack for the host determined as a target of the risk analysis.

### REFERENCE SIGNS LIST

### Risk Analysis Apparatus

11: GROUPING MEANS
12: VIRTUAL ANALYSIS ELEMENT GENERATION MEANS
13: ANALYSIS MEANS
14: ANALYSIS TARGET ELEMENT DETERMINATION MEANS
15: ANALYSIS MEANS
20: ANALYSIS TARGET ELEMENT DETERMINATION APPARATUS
100: RISK ANALYSIS APPARATUS
101: GROUPING MEANS
102: REPRESENTATIVE HOST GENERATION UNIT
103: FIRST RISK ANALYSIS UNIT
104: ANALYSIS TARGET ELEMENT DETERMINATION UNIT
105: SECOND RISK ANALYSIS UNIT
110: ANALYSIS TARGET ELEMENT DETERMINATION APPARATUS
150: SYSTEM CONFIGURATION INFORMATION
200A-G,X,Y: HOST
210: FIREWALL
220A-D: REPRESENTATIVE HOST
250A-D,X,Y: SUBNET
500: COMPUTER APPARATUS
510: CPU
520: STORAGE UNIT
530: ROM
540: RAM
550: COMMUNICATION IF
560: USER IF

What is claimed is:

1. An analysis target element determination apparatus comprising:
a memory storing instructions; and
a processor configured to execute the instructions to:
group a plurality of hosts included in a system to be analyzed into a plurality of groups, each group including one or more hosts;
generate at least one virtual analysis element for each of the plurality of groups;
perform an analysis of whether an attack against the virtual analysis element of a group where a host that is an end point of the attack belongs is possible from the virtual analysis element of a group where a host that is a starting point of the attack belongs by using the virtual analysis element; and
determine, as a target of a risk analysis, a host corresponding to the virtual analysis element included in a path where the attack occurs among hosts included in the system to be analyzed on the basis of an analysis result of the analysis.

2. The analysis target element determination apparatus according to claim 1, wherein the processor is configured to execute the instructions to generate, as the virtual analysis element, a representative host that is a virtual host corresponding to one or more hosts among hosts belonging to the group.

3. The analysis target element determination apparatus according to claim 2, wherein the processor is configured to execute the instructions to merge attackable elements of hosts belonging to the group, and uses the merged attackable elements as an attackable element of the representative host.

4. The analysis target element determination apparatus according to claim 2, wherein the processor is configured to execute the instructions to select a host with the largest number of attackable elements or one or more hosts with a predetermined number or more of attackable elements among hosts belonging to the group, and use the attackable element of the selected host as an attackable element of the representative host.

5. The analysis target element determination apparatus according to claim 2, wherein the processor is configured to execute the instructions to select a host having an attackable element from a host of another group among hosts belonging to the group, and uses the attackable element of the selected host as an attackable element of the representative host.

6. The analysis target element determination apparatus according to claim 2, wherein the processor is configured to execute the instructions to exclude, from a target of the risk analysis, a host corresponding to the representative host not included in a path where the attack occurs among hosts included in the system to be analyzed.

7. The analysis target element determination apparatus according to claim 2, wherein, in each partitioned unit, which is obtained by partitioning the system to be analyzed into predetermined units, the processor is configured to execute the instructions to analyze whether a transition is possible from each state of a representative host that is a starting point of the partitioned unit to each state of a representative host that is an end point of the partitioned unit.

8. The analysis target element determination apparatus according to claim 7, wherein the processor is configured to execute the instructions to exclude, from a target of the risk analysis, a state of a representative host that is the starting point and a state of a representative host that is the end point not included in a path where the attack occurs.

9. The analysis target element determination apparatus according to claim 2, wherein
in each partitioned unit, which is obtained by partitioning the system to be analyzed into predetermined units, the processor is configured to execute the instructions to analyze whether a transition is possible from each state of a host that is a starting point of the partitioned unit to each state of a host that is an end point of the partitioned unit, and
the processor is configured to execute the instructions to generate the representative host for each host having an attackable element that reaches each state of the host that is the end point of the partitioned unit.

10. The analysis target element determination apparatus according to claim 9, wherein the processor is configured to execute the instructions to identify a representative host not used for the attack, and excludes, from a target of the risk analysis, a state of a host that is an end point corresponding to the identified representative host.

11. The analysis target element determination apparatus according to claim 1, wherein the processor is configured to execute the instructions to group the hosts for each subnetwork to which the hosts belong.

12. The analysis target element determination apparatus according to claim 1, wherein the processor is configured to execute the instructions to group the hosts for each range of the system to be analyzed separated by a predetermined boundary.

13. The analysis target element determination apparatus according to claim 1, wherein the processor is configured to execute the instructions to group the hosts for each role of the hosts.

14. The analysis target element determination apparatus according to claim 1, wherein the processor is configured to execute the instructions to group the hosts for each configuration of the hosts.

15. A risk analysis apparatus comprising:
a memory storing instructions; and
a processor configured to execute the instructions to:
group a plurality of hosts included in a system to be analyzed into a plurality of groups, each group including one or more hosts;
generate at least one virtual analysis element for each of the plurality of groups;
perform a first analysis of whether an attack against the virtual analysis element of a group where a host that is an end point of the attack belongs is possible from the virtual analysis element of a group where a host that is a starting point of the attack belongs by using the virtual analysis element;
determine, as a target of a risk analysis, a host corresponding to the virtual analysis element included in a path where the attack occurs among hosts included in the system to be analyzed on the basis of an analysis result of the first analysis; and
perform a second analysis of whether an attack against the host that is the end point of the attack is possible from the host that is the starting point of the attack, for the host determined as a target of the risk analysis.

16. The risk analysis apparatus according to claim 15, wherein the processor is configured to execute the instructions to generate, as the virtual analysis element, a representative host that is a virtual host corresponding to one or more hosts among hosts belonging to the group.

17. The risk analysis apparatus according to claim 16, wherein the processor is configured to execute the instructions to merge attackable elements of hosts belonging to the group, and uses the merged attackable elements as an attackable element of the representative host.

18. The risk analysis apparatus according to claim 16, wherein the processor is configured to execute the instructions to exclude, from a target of the risk analysis, a host corresponding to the representative host not included in a path where the attack occurs among hosts included in the system to be analyzed.

19. The risk analysis apparatus according to claim 16, wherein
in each partitioned unit, which is obtained by partitioning the system to be analyzed into predetermined units, the processor is configured to analyze, in the first analysis, whether a transition is possible from each state of a representative host that is a starting point of the partitioned unit to each state of a representative host that is an end point of the partitioned unit, and
in each partitioned unit, which is obtained by partitioning the system to be analyzed into predetermined units, the processor is configured to analyze, in the second analysis, whether a transition is possible from each state of a host that is a starting point of the partitioned unit to each state of a host that is an end point of the partitioned unit.

20. The risk analysis apparatus according to claim 16, wherein
in each partitioned unit, which is obtained by partitioning the system to be analyzed into predetermined units, the processor is configured to analyze, in the second analysis, whether a transition is possible from each state of a host that is a starting point of the partitioned unit to each state of a host that is an end point of the partitioned unit, and
the processor is configured to generate the representative host for each host having an attackable element that reaches each state of the host that is the end point of the partitioned unit.

21. The risk analysis apparatus according to claim 20, wherein the processor is configured to identify a representative host not used for the attack, and excludes, from a target of the risk analysis, a state of a host that is an end point corresponding to the identified representative host.

22. An analysis target element determination method comprising:
grouping a plurality of hosts included in a system to be analyzed into a plurality of groups, each group including one or more hosts;
generating at least one virtual analysis element for each of the plurality of groups;
analyzing whether an attack against the virtual analysis element of a group where a host that is an end point of the attack belongs is possible from the virtual analysis element of a group where a host that is a starting point of the attack belongs by using the virtual analysis element; and
determining, as a target or a risk analysis, a host corresponding to the virtual analysis element included in a path where the attack occurs among hosts included in the system to be analyzed on the basis of a result of the analysis.

23. A risk analysis method comprising:
grouping a plurality of hosts included in a system to be analyzed into a plurality of groups, each group including one or more hosts;
generating at least one virtual analysis element for each of the plurality of groups;
analyzing whether an attack against the virtual analysis element of a group where a host that is an end point of the attack belongs is possible from the virtual analysis element of a group where a host that is a starting point of the attack belongs by using the virtual analysis element;
determining, as a target of a risk analysis, a host corresponding to the virtual analysis element included in a path where the attack occurs among hosts included in the system to be analyzed on the basis of a result of the analysis; and
analyzing whether an attack against the host that is the end point of the attack is possible from the host that is the starting point of the attack for the host determined as a target of the risk analysis.

24. (canceled)
